(19) United States
(12) Patent Application Publication
(10) Pub. No.: US 2024/0015064 A1
(43) Pub. Date: Jan. 11, 2024

(54) Methods and System for Feature Management

(71) Applicant: Charter Communications Operating, LLC, St. Louis, MO (US)

(72) Inventors: Christopher L. GATES, Parker, CO (US); Jonathan SVEDE, Centennial, CO (US); Brian L. CALACI, Denver, CO (US)

(21) Appl. No.: 17/862,089

(22) Filed: Jul. 11, 2022

(51) Int. Cl. H04L 41/0813; H04L 41/50

(52) U.S. Cl. CPC H04L 41/0813; H04L 41/50

(57) ABSTRACT

Systems, devices and methods for managing features in a service provider network. A computing device (e.g., feature manager, etc.) may be configured to receive a trigger message that identifies a feature for evaluation, collect data related to the feature from an external, third party or partner system, apply the data to a rule to generate a result, and use the generated result to determine whether the feature should be enabled. The computing device may also determine whether the feature is currently enabled. The computing device may configure or toggle the feature in response to determining that feature should be enabled and is currently not enabled. Similarly, the computing device may configure or toggle the feature in response to determining that feature should not be enabled and is currently enabled.

### BACKGROUND

Wireline and wireless communication technologies have seen dramatic improvements over the past few years. Service providers now offer users a wide array of services, higher usage limits, and attractive subscription plans. Wireless dongles and embedded wireless modem cards allow users to use tablet computers, netbooks and laptops to access Internet protocol (IP) and data services through wireless networks. Internet-enabled smart phones, tablets, televisions, and gaming consoles have become essential personal accessories, connecting users to family, friends, work, leisure activities and entertainment. Users now have more choices and demand to have continuous and uninterrupted access to content, data and communications at any time. For these and other reasons, around 80% of residential internet traffic is currently through wireless communications or wireless devices.

The proliferation of these new services has increased the complexity of managing complex features on user and network devices. These services often contribute significantly to the overhead/operating expenses of an enterprise (e.g., service providers, etc.) and/or prevent service providers from offering their customers with additional services or more cost efficient services. For example, service providers are forced to implement and/or utilize manual or expensive solutions for activating or deactivating features. These solutions often contribute significantly to the overhead/operating expenses of an enterprise (e.g., service providers, etc.) and/or prevent service providers from offering their customers with additional services or more cost efficient services.

### SUMMARY

The various aspects include methods of managing features in a service provider network, which may include receiving, by a processor in a computing device, a trigger message that identifies a feature for evaluation, collecting, by the processor, data related to the feature from an external, third party or partner system, applying, by the processor, the data to a rule to generate a result, and using, by the processor, the generated result to determine whether the feature should be enabled.

In some aspects, the method may further include determining whether the feature is currently enabled. In some aspects, the method may further include toggling the feature in response to determining that feature should be enabled and that the feature is currently not enabled or toggling the feature in response to determining that feature should not be enabled and that the feature is currently enabled.

In some aspects, toggling the feature in response to determining that feature should be enabled and that the feature is currently not enabled or toggling the feature in response to determining that feature should not be enabled and that the feature is currently enabled may include sending a command to a command dispatcher included in a vendor domain via a messaging broker. In some aspects, toggling the feature in response to determining that feature should be enabled and that the feature is currently not enabled or toggling the feature in response to determining that feature should not be enabled and that the feature is currently enabled may include toggling a feature that is not hardware specific, chip specific, vendor specific, interface specific or networking specific.

In some aspects, receiving the trigger message that identifies the feature for evaluation may include receiving the trigger message in response to a rebooting of a customer premise device (CPE). In some aspects, receiving the trigger message in response to the rebooting of the CPE may include receiving a trigger message that indicates that the processor should reevaluate rules associated with the CPE to identify features of the CPE that should be enabled and features of the CPE that should be disabled.

Further aspects may include a computing device having a processor configured with processor-executable instructions to perform various operations corresponding to the methods discussed above.

Further aspects may include a non-transitory processor-readable storage medium having stored thereon processor-executable instructions configured to cause a processor to perform various operations corresponding to the method operations discussed above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of various embodiments.

FIGS. 1A and 1B are simplified block diagrams illustrating example systems that could implement or benefit from the various embodiments.

FIGS. 2A and 2B are block diagrams illustrating various components that are suitable for inclusion or use with the various embodiments.

FIG. 3 is a simplified block diagram illustrating an environment agnostic feature management system configured in accordance with some embodiments.

FIGS. 4A and 4B are service level block diagrams illustrating an example environment agnostic feature management system suitable for implementing some embodiments.

FIGS. 5A and 5B are a process flow diagrams illustrating methods of managing features in a service provider network in accordance with some embodiments.

FIG. 6 is a component diagram of an example computing server device suitable for implementing the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

In overview, the various embodiments include methods, and computing devices configured to implement the methods, for providing feature management on devices that are included in or associated with a service provider network (e.g., routers, customer premises equipment (CPE) devices, user equipment devices, etc.). Some embodiments may include a feature management component that is configured to determine whether a specific feature (e.g., Speed Boost®, Spectrum Mobile Home Network®, etc.) should be enabled or disabled on a specific router, determine whether the specific feature is currently enabled or disabled, and cause the router (or another component) to enable or disable the specific feature accordingly. In some embodiments, the feature management component may be configured to provide service providers with fine grained control of the features on routers in the field in a way that is vendor agnostic, and allow the third-parties or vendors (e.g., amazon web services, etc.) to better control the consumption and scale in accordance with their overall platform.

The feature management component may be configured to overcome various technical challenges associated with horizontal scaling, improve the efficiency of the service provider network, and/or reduce operating costs. For these and other reasons, the feature management component may improve the performance and functioning of the service provider network and its constituent components.

The terms “component,” “system,” and the like may be used herein to refer to a computer-related entity (e.g., hardware, firmware, a combination of hardware and software, software, software in execution, etc.) that is configured to perform particular operations or functions. For example, a component may be, but is not limited to, a process running on a processor, a processor, an object, an executable, a thread of execution, a program, and/or a computing device. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

The term “service provider network” is used generically herein to refer to any network suitable for providing consumers with access to the Internet or IP services over broadband connections. Service provider networks may encompass both wired and wireless networks/technologies. Examples of wired network technologies and networks that may be included within a service provider network include cable networks, fiber optic networks, hybrid-fiber-cable networks, Ethernet, local area networks (LAN), metropolitan area networks (MAN), wide area networks (WAN), networks that implement the data over cable service interface specification (DOCSIS), networks that utilize asymmetric digital subscriber line (ADSL) technologies, etc. Examples of wireless network technologies and networks that may be included within a service provider network include third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), high-speed downlink packet access (HSDPA), 3GSM, general packet radio service (GPRS), code division multiple access (CDMA) systems (e.g., cdmaOne, CDMA2000™), enhanced data rates for GSM evolution (EDGE), advanced mobile phone system (AMPS), digital AMPS (IS-135/TDMA), evolution-data optimized (EV-DO), digital enhanced cordless telecommunications (DECT), Worldwide Interoperability for Microwave Access (WIMAX), wireless local area network (WLAN), Wi-Fi Protected Access I & II (WPA, WPA2), Bluetooth®, land mobile radio (LMR), and integrated digital enhanced network (iden). Each of these wired and wireless technologies involves, for example, the transmission and reception of data, signaling and/or content messages.

Any references to terminology and/or technical details related to an individual wired or wireless communications standard or technology are for illustrative purposes only, and not intended to limit the scope of the claims to a particular communication system or technology unless specifically recited in the claim language.

The term “infrastructure as a service (IaaS)” may be used in this application to refer to a component or a system that provides consumers with basic or fundamental computing infrastructure resources (e.g., computing power, memory, network connectivity, disk space, etc.) via a cloud computing environment or over the Internet. An IaaS system may eliminate the need for network operators and/or equipment manufacturers to buy and manage proprietary computing resources or appliances. An IaaS system may rely on virtualization and/or offer computing infrastructure as virtual machines or as virtualized computing resources.

The term “software defined networking (SDN)” may be used in this application to refer to components or systems that enable network programmability by utilizing an IaaS system, separating the management and control plane from the data plane, providing a programmable interface to network equipment, giving centralized control over network equipment without requiring physical access, etc.

The terms “user equipment (UE)” and “attached devices” may be used interchangeably herein to refer to any one or all of satellite or cable set top boxes, laptop computers, rack mounted computers, routers, cellular telephones, smart phones, internet of things (IOT) devices, personal or mobile multi-media players, personal data assistants (PDAs), customer-premises equipment (CPE), personal computers, tablet computers, smart books, palm-top computers, desk-top computers, wireless electronic mail receivers, multimedia Internet enabled cellular telephones, wireless gaming controllers, streaming media players (such as, ROKU™), smart televisions, digital video recorders (DVRs), modems, routers, network switches, residential gateways (RG), access nodes (AN), bridged residential gateway (BRG), fixed mobile convergence products, home networking adapters and Internet access gateways that enable consumers to access communications service providers' services and distribute them around their house via a local area network (LAN), and similar electronic devices which include a programmable processor and memory and circuitry for providing the functionality described herein.

Many customers or subscribers to a service provider's network connect to the Internet via a customer premise equipment (CPE) component/device. A CPE may include a cable modem, digital subscriber line modem, router, switch, firewall, packet filter, wireless access point, pod (e.g., in a local mesh network, etc.) and/or a residential gateway that provide network connectivity to home or small office network. In particular, a CPE device may allow UE devices on the local area network (LAN) to connect to a wide area network (WAN) and ultimately the Internet.

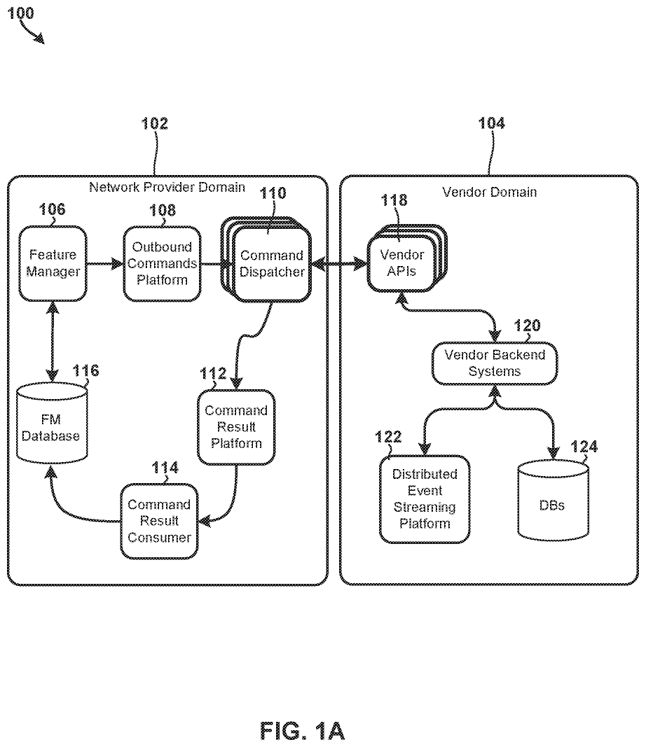

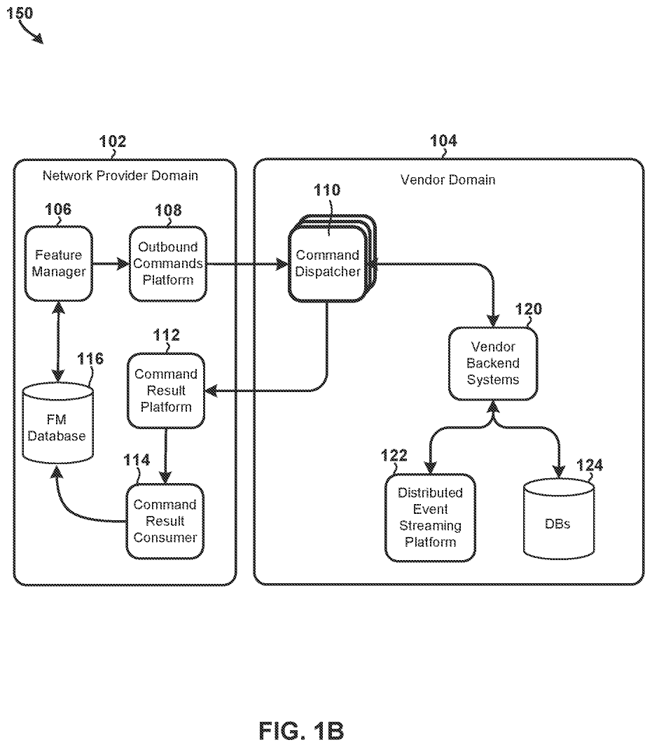

FIGS. 1A and 1B are simplified block diagrams of example systems 100, 150 that could benefit from the various embodiments. In the example illustrated in FIG. 1A, the system 100 includes a network provider domain 102 and a vendor domain 104. The network provider domain 102 includes a feature manager 106 component, an outbounds command platform 108 component, command dispatcher 110 components, a command result platform 112 component, a command results consumer 114 component, and a feature manager (FM) database 116. The vendor domain 104 includes vendor application programming interface (API) 118 components, vendor backend systems 120 component, distributed event streaming platform 122 component, and various databases 124.

The network provider domain 102 and vendor domain 104 components may each include various additional network components for providing consumers with access to the Internet or IP services over broadband connections.

The feature manager 106 component may, periodically or based on triggers, determine whether a feature (e.g., a high level router feature, etc.) should be configured on a device. For example, the feature manager 106 component may be configured to periodically determine whether a feature should be configured (e.g., enabled, disabled, toggled, etc.) on a router or CPE device. In response to determining that a feature should be configured, the feature manager 106 component may generate and send a message to the outbounds command platform 108 component, which may spawn, generate, message or invoke a command dispatcher 110 component to manage the configuration (e.g., toggling, etc.) of the corresponding feature.

FIG. 1A illustrates that the network provider domain 102 may include a separate command dispatcher 110 component for each feature and/or device. Each of these command dispatcher 110 components may require a separate vendor API 118 in the vendor domain 104. As such, configuring (or toggling between) many features (e.g., thousand requests in several minutes, etc.) may require significant horizontal scaling on both the network provider domain 102 (e.g., the command dispatcher, etc.) and the vendor domain 104 (e.g., the APIs, etc.). Since a network operator typically has to pay for vendor services, the network operator may effectively pay twice for the costs of the scaling (i.e., once in the network provider domain 102, and another in the vendor domain 104).

In addition, since the network provider domain 102 does not have any visibility into vendor domain 104, the network provider domain 102 cannot readily determine whether vendor platform has sufficient capacity to handle the requests. That is, when the network provider domain 102 issues a request to enable or disable a feature, the network provider domain 102 does not know whether the vendor platform 104 is relatively idle or relatively busy. In instances in which the vendor platform 104 is relatively busy and the network provider domain 102 floods it with additional requests, the infrastructure may become overloaded, crash, and/or otherwise cause an outage on the overall platform.

In the example illustrated in FIG. 1B, the command dispatcher 110 components are included in vendor domain 104. The outbound commands platform 108 may send commands to the command dispatcher 110 via a messaging broker (e.g., Kafka, etc.) that provides additional controls over how messages are consumed, how much it goes through, scaling, etc. This effectively eliminates the need for including vendor API 118 components in the vendor domain 104, and thus reduces costs (i.e., the network operator does not need to “pay twice” for the costs of the scaling). This system 150 also allows the vendor domain 104 to better control the consumption and scale in accordance with its overall platform. The vendor domain 104 may scale their infrastructure and have visibility into the incoming request, as opposed to just blindly waiting for a request to show up. In addition, the system 150 may be further configured so that the network provider domain 102 has fine grained control of the features on routers in the field in a way that is vendor agnostic.

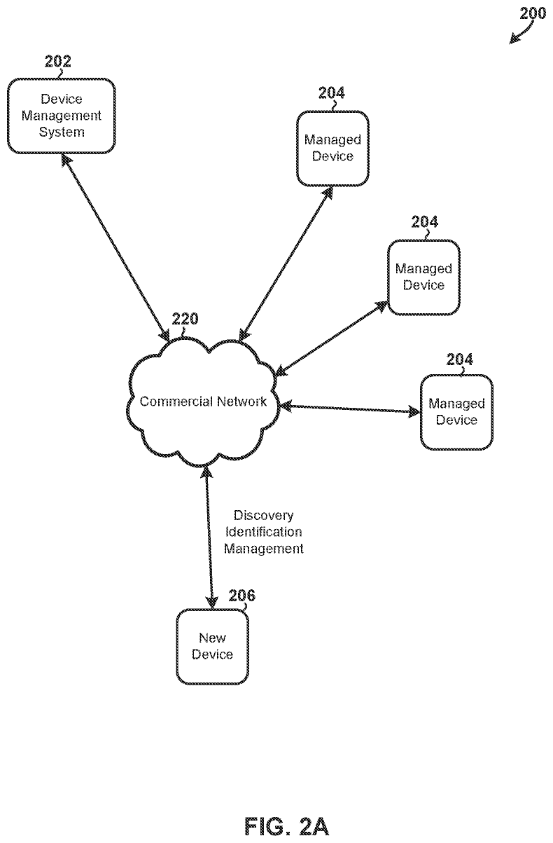

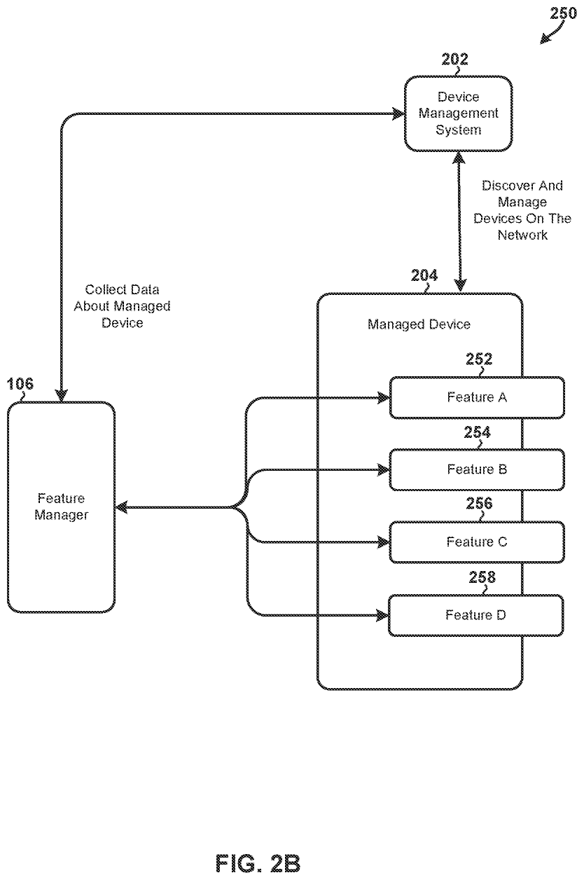

FIGS. 2A and 2B illustrate various components that are suitable for inclusion or use with the various embodiments. The system 200 illustrated in FIG. 2A includes a device management system 202, a plurality of managed devices 204, and a new device 206, any or all of which may be communicatively coupled together via a commercial network 220. The system 250 illustrated in FIG. 2B includes a feature manager 106 component, a device management system 202, and a managed device 204 that includes various features 252, 254, 256, 258.

The device management system 202 may be configured to perform device discovery, device management, and/or other similar device management operations (e.g., determine the interfaces that are enabled or disabled, etc.). Said another way, as a new device 206 (e.g., router, modem, or other piece of network infrastructure) comes onto the commercial network 220, it may be discovered, identified, and then managed by the device management system 202.

Thus, unlike the feature manager 106 component discussed above, the device management system 202 deals with hardware/chip vendor specific, interface specific and/or networking specific things (e.g., enabling Secure Shell Protocol, etc.). On the other hand, the feature manager 106 component manages features 252-258 (e.g., Spectrum Mobile Home Network, Speed Boost, advanced security, etc.) of the managed device 204 that are not hardware/chip vendor specific, interface specific or networking specific. Examples of such features include Advanced Security, Advanced Privacy, Advanced Device ID (ADID) for the identification of devices attached to the router, Adaptive Advanced Device ID, security shield, enhanced tracking and reporting, home-as-a-hotspot, speed boost, 2.4 GHz, residential hotspot such as Spectrum Mobile Network—Home (SMN-H), small business hotspot such as Spectrum Mobile Network—Business (SMN-B), Advanced Home WiFi (AHW) (including next generation wifi services such as latest wifi standards, new IOT radios and technologies), Spectrum Community Solution Services (SCS) features, AHW/SCS—Resi, ACW/SCS—Multi (family) Dwelling Unit (MDU), advanced business WiFi (ABW), ABW/SCS—SMB, Small business (SMB) features, SMB Support features, MDU Support features, modem speed test, CPE speed test, router speed test, agent speed test, Mapping of Address and Port using Translation (MAP-T), Ipv4-IPV6 mapping, Security—Listen Only, Security—Customer, Guest Pass, Multi Access Point—Pod (mesh) support, Property Service Portal (PSP), Parental Controls, Easy Connect (connect devices via QR code), On the Move, WiFi Traffic Priority, Device Class blocking, Addressability, Amazon Onboarding, CPE Validation, MAC (device address/serial) Randomization (MAC-r) which provides device identification support for randomized mac addresses, etc.

With reference to FIG. 2B, the feature manager 106 component may be configured to collect or store information (e.g., router model, firmware version, etc.) about the managed device 204. In addition, the feature manager 106 component may collect, store, or have access to information that identifies the region in which the device is located, other devices it is associated with, its opt-in features, its opt-out features, and other similar information. The feature manager 106 component may use any or all such information to control any feature (e.g., very fine grained features, very low-level features, etc.) on the router in any manner it deems necessary to accomplish a high level business objective.

The feature manager 106 component may be configured to allow vendors to integrate into a control system that lets their clients control very low-level features and/or features at various scales or levels of granularity.

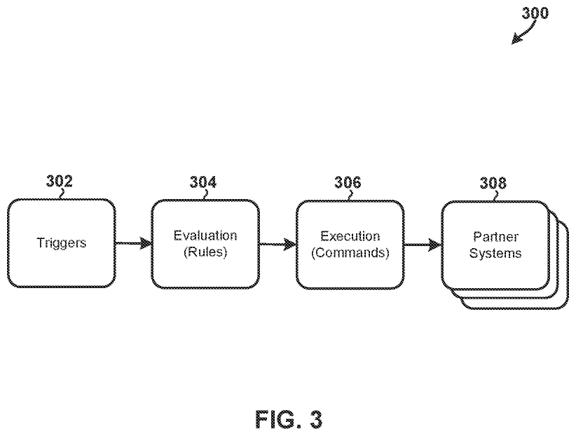

FIG. 3 is a simplified block diagram of an environment agnostic feature management system 300 in accordance with some embodiments. In the example illustrated in FIG. 3, the feature management system 300 includes triggers 302, an evaluation (rules) 304 component, an execution (commands) 306 component, and partner systems 308.

The feature management system 300 may be configured to run routers and set features that pertain to routers such that they are agnostic to the domain space.

The triggers 302 may indicate that evaluation is required of features that are going to be set on a customer account (e.g. on a router, etc.) associated with specific CPE. The triggers 302 could be actively generated by an operator through controls (e.g., “reevaluate the features for everybody in region A,” etc.). The triggers 302 may also be more passive and/or event based. For example, a trigger 302 could be generated every time a router is rebooted to indicate that the system should reevaluate all of its rules to identify the features that should be enabled and the features that should be disabled.

The evaluation (rules) 304 component may collect data from various external, third party, or partner systems, apply the data to rules to generate a result, use the result to determine the features (e.g., a high level router features, etc.) that should be enabled or disabled, determine whether those features are currently enabled or disabled, and determine whether one or more of those features should be toggled (e.g., enabled or disabled) on a device (e.g., a router, CPE, etc.). The evaluation (rules) 304 component may generate and send a message to the execution (commands) 306 component in response to determining that a feature should be toggled.

The execution (commands) 306 component may include data and logic that identify how each feature could be enabled or disabled. For example, the execution (commands) 306 component may access information that identifies the components, partner systems and API calls required to toggle a specific feature. As such, in response to receiving the message from evaluation (rules) 304 component, the execution (commands) 306 component may perform various operations and/or communicate with other components to enable or disable the relevant features.

In some embodiments, the environment agnostic feature management system 300 may be configured to customize to any triggers, customize to any rule and/or fields that a generates the rule, and/or customize to any downstream system to inform them of the operations required to toggle a feature.

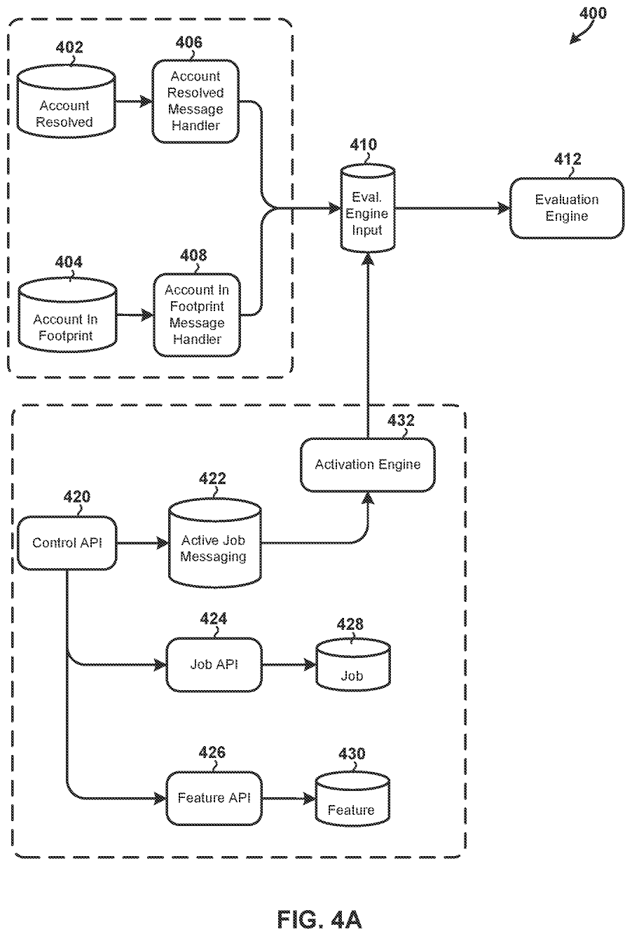

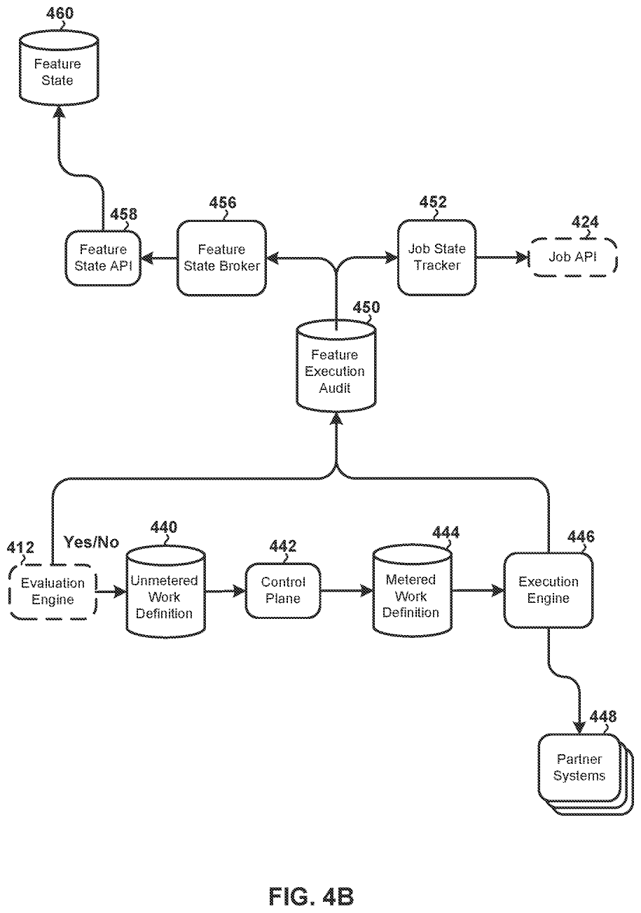

FIGS. 4A and 4B are service level block diagrams of an example environment agnostic feature management system 400 suitable for implementing the various embodiments. With reference to FIGS. 4A and 4B, the environment agnostic feature management system 400 may include an account resolved 402 database/queue, an account in footprint 404 database/queue, an account resolved message handler 406, an account in footprint message handler 408, an evaluation engine input 410 database/queue, an evaluation engine 412, a control API 420, an active job messaging 422 database/queue, a job API 424 component, a feature API 426 component, a job 428 database/queue, a feature 430 database/queue, an activation engine 432, an unmetered work definition 440 database/queue, a control plane 442 component, a metered work definition 444 database/queue, an execution engine 446, partner systems 448, a feature execution audit 450 database/queue, a job state tracker 452 component, a feature state broker 456 component, a feature state API 458 component, and a feature state 460 database/queue. Any or all of these components 402-460 may communicate via messaging based communications, which allow the system to horizontally scale.

The account resolved 402 database/queue, account in footprint 404 database/queue, account resolved message handler 406, account in footprint message handler 408 may receive or generate various triggers or messages (e.g., related to routers rebooting, etc.), convert those into an input message, and send the input message to the evaluation engine input 410 database/queue.

The evaluation engine input 410 database/queue may be configured to throttle and/or send the inputs to the evaluation engine 412 for processing.

The evaluation engine 412 may receive a data input and a rule input. The rule input may be generated using a domain specific language that allows for generating highly customizable rules. Each rule may be a simple rule (e.g., “a region needs to be a specific value”) or a complicated rule (e.g., multiple nested conditions, sub rules, sub expressions, etc.). The rules may also support a number of different operators, do exact matches and/or do more like fuzzy pattern-based Regex matches.

The evaluation engine 412 may identify the relevant fields, values and components (e.g., the relevant APIs, partner systems, router identifiers, firmware versions, etc.), collect data from all of the identified components, apply the collected data to the rules to generate an analysis result or value (e.g., Yes or No, etc.), generate a message that includes the analysis result or value, and send the generated message to the unmetered work definition 440 database/queue.

The unmetered work definition 440, the control plane 442 component, and the metered work definition 444 database/queue may work in conjunction with one another to meter and throttle the message rate. That is, if there are multitude of messages coming through the evaluation engine 412, the system needs to be able to turn that volume down to a specific level that won't harm the downstream systems. Accordingly, the unmetered work definition 440 database/queue may queue up the working definition messages, the control plane 442 component may throttle the unmetered working definition messages so that they're being produced in a metered fashion, and the metered work definition 444 database/queue may store the resulting metered work definition messages.

At the appropriate time or rate, the metered work definition 444 database/queue may send the message to the execution engine 446. The execution engine 446 may be configured to determine the APIs that should be called and/or the values that are to be included in the API calls to enable or disable a feature, and to issue calls to appropriate partner systems 448 and/or APIs.

For example, the execution engine 446 may receive a message that indicates that the Spectrum Mobile Home feature is to be toggled on. Spectrum Mobile Home is an advanced product with complex rules, specific to the point that it's only meant for people that own a certain type of mobile device to use on public channels as a guest in someone else's house or around someone else's house. In addition, Spectrum Mobile Home can only be turned up in houses with a certain bandwidth range (e.g., mid-tier, etc.) for the product they pay for with their connectivity product. It should not be used on those who have maxed out their private bandwidth or those that have basic, low bandwidth service. Other factors that could be considered are region, whether there is a test deployment in a certain area, etc. In addition, there is a speed boost feature, which may complement or interfere with the Spectrum Mobile Home feature depending on various factors and conditions. As such, the execution engine 446 may be configured to consider and evaluate any or all such factors when determining whether to toggle the feature.

As mentioned above, the execution engine 446 may be configured to apply data to rules. The rules might, at a high level, be “as our understanding is today” or “we want this to be enabled when the region of the customer is one of these several test regions that were that were initially launching to” and “where the firmware version matches a particular pattern of firmware versions that mean that the feature is fully available and ready” and “we don't want to match certain cable modems.”As another high level example, the rules may be that download speed has to be greater than or equal to X, and the download speed has to be less than or equal to Y, in which X and Y are ever-changing values over the course of time. In some embodiments, the rules may be generated using a rule syntax and/or a domain specific language that produces an expression. Some embodiments may include reusable rules, which cover common scenarios or define complex sequences.

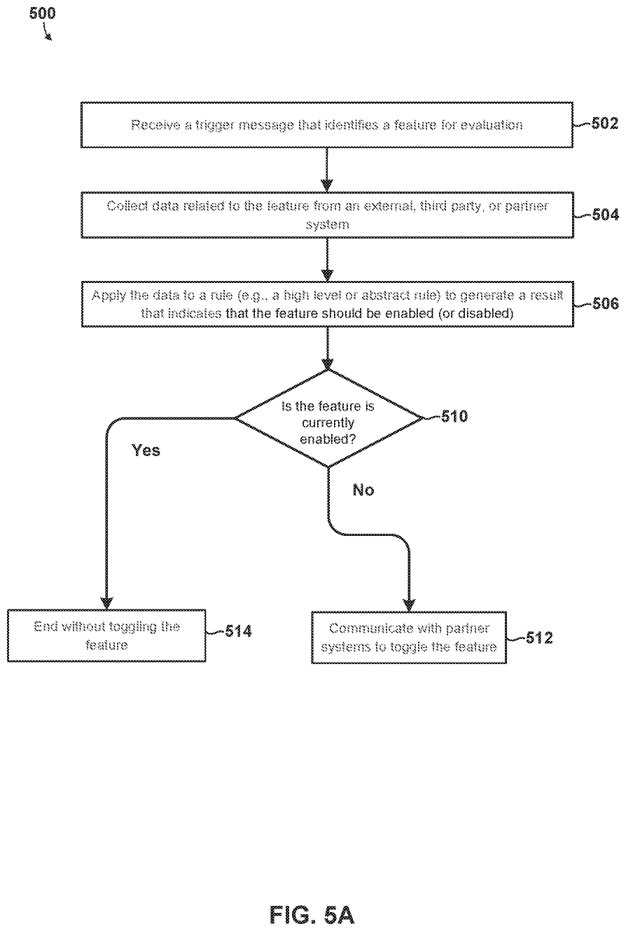

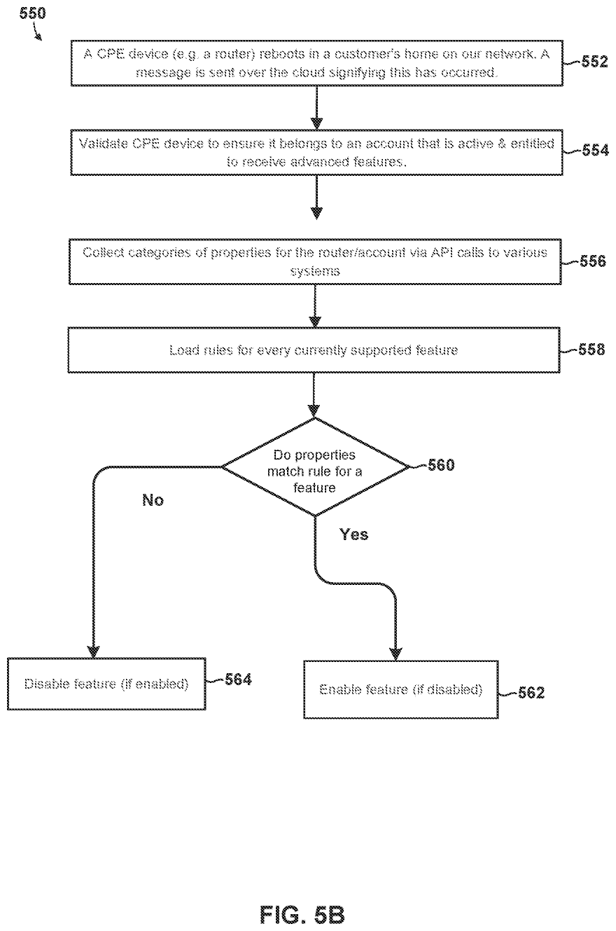

FIGS. 5A and 5B are process flow diagrams illustrating methods 500, 550 of managing features in a service provider network in accordance with some embodiments. All or portions of methods 500, 550 may be implemented by one or more processors in a feature management component.

With reference to FIG. 5A, in block 502, the feature management component may receive a trigger message that identifies a feature for evaluation or a trigger message that indicates all known features for a router should be reevaluated. In some embodiments, the feature management component may receive the trigger message when things are likely to change for an account or router deployed in the field. For example, the feature management component may receive the trigger message in response to a router restart or reboot.

In block 504, the feature management component may collect data related to the feature from an external, third party, or partner system. The collected data may include router properties, user account properties, market data, etc. The router properties may include physical capabilities of the router, such as make/model of the router, software information, firmware version, etc. The user account properties may include entitlements, subscribed download speed, other accounts and/or account types (e.g., cable account, mobile account, etc.) associated with the user, etc. The market data may include regional delimiters about the geographical location of the router, etc. Example features include security shield, enhanced tracking and reporting, home-as-a-hotspot, speed boost, etc. The external, third party, or partner system may be a polling system, cloud system (e.g., plume, CUJO, etc.), billing system, or other groups within the system that store account information. For example, the polling system may be a component in the network that polls out to the router and cable modem, and gets back information about settings on those devices or system.

In blocks 506, the feature management component may determine the features supported by a router, apply the collected data to rules to generate results that indicate whether each of the supported features should be enabled (or disabled). The rules may be logic or syntax that captures a high level statement, such as “roll out feature X to routers of type Y that have firmware version 6 or higher and exclude devices in with the user has a mobile account.” As another example, a rule may be logic or syntax that captures the high level statement “provide additional feature Z to devices that are in the Austin market and are associated with a user that subscribes to both a home cable and mobile services.”

In determination block 510, the feature management component may determine whether the feature is currently enabled in determination block 510.

In response to determining that the feature should be enabled and the feature is not currently enabled, or in response to determining that the feature should not be enabled and the feature is currently enabled (i.e., determination block 510=Yes) the feature management component may toggle the feature in block 512.

In response to determining that the feature should be enabled and the feature is currently enabled, or in response to determining that the feature should not be enabled and the feature is not currently enabled (i.e., determination block 510=No) the feature management component may end the method without toggling the feature in block 514.

With reference to FIG. 5B, in block 552, the feature management component may receive a trigger message (e.g., via a cloud network, message handler, listener, etc.) that indicates that a CPE device (e.g., router, etc.) is rebooting in a customer's home or the service provider network.

In block 554, the feature management component (or another component in the network) may validate the CPE device to ensure that it belongs to an account that is active and entitled to receive advanced features. Examples of such features may include Advanced Security, Advanced Privacy, Advanced Device ID (ADID) for the identification of devices attached to the router, Adaptive Advanced Device ID, security shield, enhanced tracking and reporting, home-as-a-hotspot, speed boost, 2.4 GHz, SMN-H, SMN-B Hotspot for business, AHW/SCS—Resi, ACW/SCS—MDU, ABW/SCS—SMB, SMB Support features, MDU Support features, modem speed test, CPE speed test, router speed test, agent speed test, MAP-T (Ipv4-IPV6 mapping), Security—Listen Only, Security—Customer, Guest Pass, M-AP (pods), PSP, Parental Controls, Easy Connect (connect devices via QR code), On the Move, WiFi Traffic Priority, Device Class blocking, Addressability, Amazon Onboarding, CPE Validation, MAC-r.

In block 556, the feature management component (or another component in the network) may collect various categories of properties for the CPE device or user account (e.g., via API calls to various systems, etc.). Example of the categories of properties that may be collected in block 556 include hardware information, customer account information, and marketing account information, any or all of which may include properties such as account region, router model, router firmware version, cable modem make, cable modem model, subscribed download speed, other subscribed services (e.g. mobile service), and/or various other entitlements.

In block 558, the feature management component (or another component in the network) may load rules for every currently supported feature (e.g., every feature currently supported by the CPE device, user account, etc.).

In some embodiments, the rules may be boolean expressions that combine the router/account properties collected above and evaluate them against specific values or patterns. For example, a rule for filtering/enabling Advanced Security may be “region==‘austintx’ AND routerModel==‘ABC123’ AND downloadSpeed>=1000000000 AND routerFirmwareVersion>=‘3.0.2’”.

In some embodiments, at a high level, the rules might be “as our understanding is today” or “we want this to be enabled when the region of the customer is one of these several test regions that were that were initially launching to” and “where the firmware version matches a particular pattern of firmware versions that mean that the feature is fully available and ready” and “we don't want to match certain cable modems.” In some embodiments, each rule may be a simple rule (e.g., “a region needs to be a specific value”) or a complicated rule (e.g., multiple nested conditions, sub rules, sub expressions, etc.). The rules may also support a number of different operators, do exact matches and/or do more like fuzzy pattern-based Regex matches.

In determination block 560, the feature management component (or another component in the network) may determine whether the properties match the rules for each feature. For example, the feature management component may apply the property data to a rule to generate a result, and use the result to determine whether a specific feature should be enabled or disabled.

Said another way, the feature management component may determine whether the account/CPE passes or fails the rules for each feature based on their properties in block 560. For example, if the rule is “region==‘austintx’ AND routerModel==‘ABC123’ AND downloadSpeed>=1000000000 AND routerFirmwareVersion>=‘3.0.2’”, and the properties indicate that the CPE's region is “austintx”, router model is “ABC123”, download speed is 2000000000, and router firmware version is 4.0.0, then the result is that the properties match the rule (i.e., determination block 560=“Yes”).

In response to determining that the properties match a rule (i.e., determination block 560=“Yes”), the feature management component may enable the feature (if disabled) in block 562.

In response to determining that the properties do not match a rule (i.e., determination block 560=“No”), the feature management component may disable the feature (if enabled) in block 564.

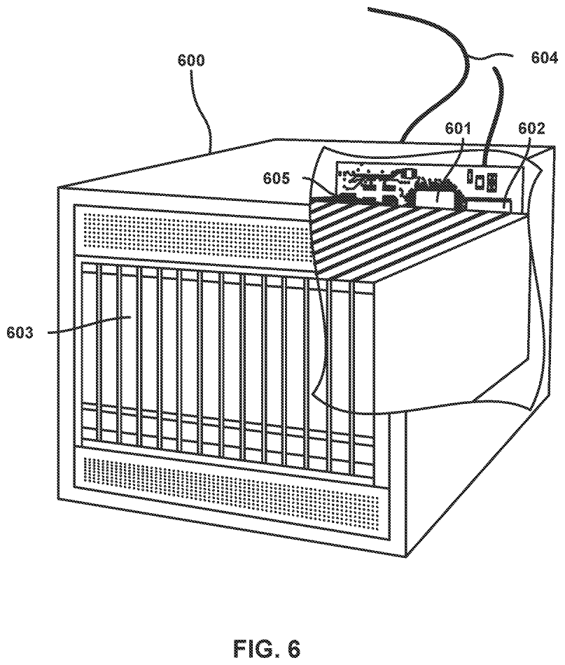

Various embodiments may be implemented on any of a variety of commercially available computing devices, such as the computing device 600 illustrated in FIG. 6. Such a computing device 600 may include a processor 601 coupled to volatile memory 602 and a large capacity nonvolatile memory, such as a disk drive 603. The computing device 600 may also include network access ports 605 coupled to the processor 601 for establishing data connections with a network connection circuit 604 and a communication network (e.g., IP network) coupled to other communication system network elements.

The processors discussed in this application may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before they are accessed and loaded into the processors. The processors may include internal memory sufficient to store the application software instructions. In many devices, the internal memory may be a volatile or nonvolatile memory, such as flash memory, or a mixture of both. For the purposes of this description, a general reference to memory refers to memory accessible by the processors including internal memory or removable memory plugged into the device and memory within the processors themselves. Additionally, as used herein, any reference to a memory may be a reference to a memory storage and the terms may be used interchangeable.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module and/or processor-executable instructions, which may reside on a non-transitory computer-readable or non-transitory processor-readable storage medium. Non-transitory server-readable, computer-readable or processor-readable storage media may be any storage media that may be accessed by a computer or a processor. By way of example but not limitation, such non-transitory server-readable, computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, DVD, floppy disk, and Blu-ray disc where disks usually reproduce data magnetically, while discs reproduce data optically with lasers. Combinations of the above are also included within the scope of non-transitory server-readable, computer-readable and processor-readable media. Additionally, the operations of a method or algorithm may reside as one or any combination or set of codes and/or instructions on a non-transitory server-readable, processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of managing features in a service provider network, comprising:
receiving, by a processor in a computing device, a trigger message that identifies a feature for evaluation;
collecting, by the processor, data related to the feature from an external, third party, or partner system;
applying, by the processor, the data to a rule to generate a result; and
using, by the processor, the generated result to determine whether the feature should be enabled.

2. The method of claim 1, further comprising determining whether the feature is currently enabled.

3. The method of claim 2, further comprising:
toggling the feature in response to determining that feature should be enabled and that the feature is currently not enabled; or
toggling the feature in response to determining that feature should not be enabled and that the feature is currently enabled.

4. The method of claim 3, wherein toggling the feature in response to determining that feature should be enabled and that the feature is currently not enabled or toggling the feature in response to determining that feature should not be enabled and that the feature is currently enabled comprises sending a command to a command dispatcher included in a vendor domain via a messaging broker.

5. The method of claim 3, wherein toggling the feature in response to determining that feature should be enabled and that the feature is currently not enabled or toggling the feature in response to determining that feature should not be enabled and that the feature is currently enabled comprises toggling a feature that is not hardware specific, chip specific, vendor specific, interface specific or networking specific.

6. The method of claim 1, wherein receiving the trigger message that identifies the feature for evaluation comprises receiving the trigger message in response to a rebooting of a customer premise device (CPE).

7. The method of claim 6, wherein receiving the trigger message in response to the rebooting of the CPE comprises receiving a trigger message that indicates that the processor should reevaluate rules associated with the CPE to identify features of the CPE that should be enabled and features of the CPE that should be disabled.

8. A computing device, comprising:
a processor configured to:
receive a trigger message that identifies a feature for evaluation;
collect data related to the feature from an external, third party, or partner system;
apply the data to a rule to generate a result; and
use the generated result to determine whether the feature should be enabled.

9. The computing device of claim 8, wherein the processor is further configured to determine whether the feature is currently enabled.

10. The computing device of claim 9, wherein the processor is further configured to:
toggle the feature in response to determining that feature should be enabled and that the feature is currently not enabled; or
toggle the feature in response to determining that feature should not be enabled and that the feature is currently enabled.

11. The computing device of claim 10, wherein the processor is further configured to toggle the feature in response to determining that feature should be enabled and that the feature is currently not enabled or toggle the feature in response to determining that feature should not be enabled and that the feature is currently enabled by sending a command to a command dispatcher included in a vendor domain via a messaging broker.

12. The computing device of claim 10, wherein the processor is further configured to toggle the feature in response to determining that feature should be enabled and that the feature is currently not enabled or toggle the feature in response to determining that feature should not be enabled and that the feature is currently enabled by toggling a feature that is not hardware specific, chip specific, vendor specific, interface specific or networking specific.

13. The computing device of claim 8, wherein the processor is further configured to receive the trigger message that identifies the feature for evaluation by receiving the trigger message in response to a rebooting of a customer premise device (CPE).

14. The computing device of claim 13, wherein the processor is further configured to receive the trigger message in response to the rebooting of the CPE by receiving a trigger message that indicates that the processor should reevaluate rules associated with the CPE to identify features of the CPE that should be enabled and features of the CPE that should be disabled.

15. A non-transitory computer readable storage medium having stored thereon processor-executable software instructions configured to cause a processor to perform operations for managing features in a service provider network, comprising:
receiving a trigger message that identifies a feature for evaluation;
collecting data related to the feature from an external, third party, or partner system;
applying the data to a rule to generate a result; and
using the generated result to determine whether the feature should be enabled.

16. The non-transitory computer readable storage medium of claim 15, wherein the stored processor-executable software instructions are configured to cause a processor to perform operations further comprising determining whether the feature is currently enabled.

17. The non-transitory computer readable storage medium of claim 16, wherein the stored processor-executable software instructions are configured to cause a processor to perform operations further comprising:
toggling the feature in response to determining that feature should be enabled and that the feature is currently not enabled; or
toggling the feature in response to determining that feature should not be enabled and that the feature is currently enabled.

18. The non-transitory computer readable storage medium of claim 17, wherein the stored processor-executable software instructions are configured to cause a processor to perform operations such that toggling the feature in response to determining that feature should be enabled and that the feature is currently not enabled or toggling the feature in response to determining that feature should not be enabled and that the feature is currently enabled comprises sending a command to a command dispatcher included in a vendor domain via a messaging broker.

19. The non-transitory computer readable storage medium of claim 17, wherein the stored processor-executable software instructions are configured to cause a processor to perform operations such that toggling the feature in response to determining that feature should be enabled and that the feature is currently not enabled or toggling the feature in response to determining that feature should not be enabled and that the feature is currently enabled comprises toggling a feature that is not hardware specific, chip specific, vendor specific, interface specific or networking specific.

20. The non-transitory computer readable storage medium of claim 15, wherein the stored processor-executable software instructions are configured to cause a processor to perform operations such that receiving the trigger message that identifies the feature for evaluation comprises receiving the trigger message in response to a rebooting of a customer premise device (CPE).

21. The non-transitory computer readable storage medium of claim 20, wherein the stored processor-executable software instructions are configured to cause a processor to perform operations such that receiving the trigger message in response to the rebooting of the CPE comprises receiving a trigger message that indicates that the processor should reevaluate rules associated with the CPE to identify features of the CPE that should be enabled and features of the CPE that should be disabled.
